(19) United States
(12) Patent Application Publication
(10) Pub. No.: US 2007/0127092 A1
(43) Pub. Date: Jun. 7, 2007

(54) Method and Device for Optically Determining Colors of Objects

(76) Inventor: Hubert Kammer, Bischoffen (DE)

Correspondence Address: ST. ONGE STEWARD JOHNSTON & REENS, LLC, 986 BEDFORD STREET, STAMFORD, CT, 06905-5619, US

(21) Appl. No.: 11/562,818

(22) Filed: Nov. 22, 2006

Related U.S. Application Data
(63) Continuation of application No. PCT/EP05/05432, filed on May 19, 2005.

(51) Int. Cl. H04N 1/46

(52) U.S. Cl. 358/500

(57) ABSTRACT

A process to optically determine the color of objects by means of at least one light source for illuminating the object as well as a sensor element for detecting the color data emitted by the object. A method, which allows an exact feedback of the color data along with high resolution density is characterized by the steps of a) ascertaining at least one reference value by means of an object with known color data, b) equalizing the detected color data of an object that is to be determined to the at least one reference value by means of an illumination of the object to be determined that can be individually adjusted with respect to the color and c) determining the color of the object from the comparison in step b) of the process of adjusted illumination color values, with the at least reference value.

### CROSS-REFERENCE TO RELATED APPLICATIONS

The present application is a continuation of pending International patent application PCT/EP2005/005432 filed on May 19, 2005 which designates the United States and claims priority from German patent application 10 2004 025 489.3 filed on May 22, 2004, the content of which is incorporated herein by reference.

### FIELD OF THE INVENTION

The invention relates to a method for optically determining colors of objects by means of at least one light source to illuminate the object and a sensor element to detect the color data emitted by the object. The invention further relates to a device to apply the method.

### BACKGROUND OF THE INVENTION

For optical color determination of objects, it is known in the art to use CCD video cameras as sensor elements. To capture color information these CCD video cameras have a number of pixels, which are sensitive in various wavelength bands. For this purpose pixels are usually used that are sensitive to the colors red, green, and blue (RGB). To be able to emit the color of an examined object with exactitude, with known methods three pixels are always required in order to be able to produce every desired color from red, green, and blue.

A generic color determination method is known, for instance, from U.S. Pat. No. 5,850,472 A. With this known method, in a first step a calibration of the three RGD color canals of the color video camera takes place by means of a white sample. These ascertained values are filed as reference values. In the following step of the process of color measurement of an unknown sample, averages of the RGB values are ascertained and compared with the values ascertained during the calibration, and from the difference the color of the test is calculated.

In addition to the fact that the color-sensitive pixels are expensive, the resolution of a CCD video camera equipped in this manner is restricted by the fact that three pixels are required at any time in order to process the color data unequivocally.

Consequently, the object of the invention is to create a method for optical color determination of objects that at high resolution densities allows an exact reproduction of the color data. Another object of the invention is to produce a device for applying the method.

### SUMMARY OF THE INVENTION

Concerning the method, this object is fulfilled by the invention in a manner characterized by the following steps:
a) Ascertain at least one reference value by means of an object with known color data;
b) Equalize the detected color data of an object to be determined to the at least one reference value ascertained in step a) by means of an illumination of the object (2) to be determined that can be adjusted individually with respect to color; and
c) Determine the color of the object from the comparison in step b) of adjusted illumination color values with the at least one reference value ascertained in step a).

By ascertaining the at least one reference value on the basis of an object of known color and the following equalizing of detected color data to the reference value, it is possible for the first time with the method according to this invention to make color determinations with a monochromatic, especially a black-and-white CCD video camera. The equipment is not only more cost-effective than the known color video cameras; in addition it allows a three-fold greater resolution density because only one pixel is sufficient for recording the complete color data.

To accelerate the work of this method it is proposed according to a practical embodiment of the invention that the values entered in step b) of the process should be stored as reference values for the color determined in step c) and should be retrieved for the following color determinations. These color data that can be retrieved as new reference values facilitate and accelerate the equalizing in step b).

According to a practical embodiment of the invention it is proposed that in step a) an intensity wavelength diagram is used as a reference value. This diagram, whose axis values can be detected easily and exactly, allows a clear, overseeable depiction of the received color data and allows equalization of the detected values to the particular reference values in a manner that is graphic as well as simple to execute.

In order to be able in step b) to adjust the illumination of the object individually attuned to the color of the object in such a way that the detected color data can be equalized as precisely as possible to the previously ascertained reference values, it is proposed with the invention that all physical properties that determine a color, namely color tone, brightness, and color intensity, of every individual illuminating element can be individually adjusted to the light source independently of one another.

Individual adjustment of the illumination of the object can be achieved in particular, according to the invention, if light in the colors red, green, and/or blue can be irradiated by means of each illuminating element of the light source onto the object to be determined.

It is further proposed with the method of this invention that the surface of the object is divided into individual partial surfaces, so that the color of each partial surface can be individually determined in order to be able to detect exactly color processes of the surface color of the object to be determined.

Finally the invention proposes a device for optical color determination of objects to execute the inventive method, so that the device includes a light source for illuminating the object as well as a sensor element to detect color data emitted by the object. The inventive device is characterized in that the sensor element is a monochromatic, preferably a black-and-white, video camera. The inventive device allows for the first time the detection of the complete color data with just one pixel, as was previously known only for entirely black-and-white registration.

To configure the at least one light source by means of which the object to be determined can be illuminated with an individually adjustable light, it is proposed with the invention that the light source should consist of a number of individually controllable illuminating elements, preferably light-conducting fibers.

Additional characteristics and advantages of the invention can be seen with reference to the appended illustrations, which portray by way of example an embodiment of a device according to the invention for optically determining the color of objects as well as its manner of functioning.

### BRIEF DESCRIPTION OF THE DRAWINGS

FIG. 1 shows a schematic depiction of a device according to the invention for optical color determination of objects;

FIG. 2 shows a schematic depiction of an individual illumination field;

FIG. 3 shows a schematic depiction of the steps in the method for ascertaining a reference value; and

FIG. 4 shows a schematic depiction of the steps in the method for equalizing detected color data.

### DETAILED DESCRIPTION OF THE INVENTION

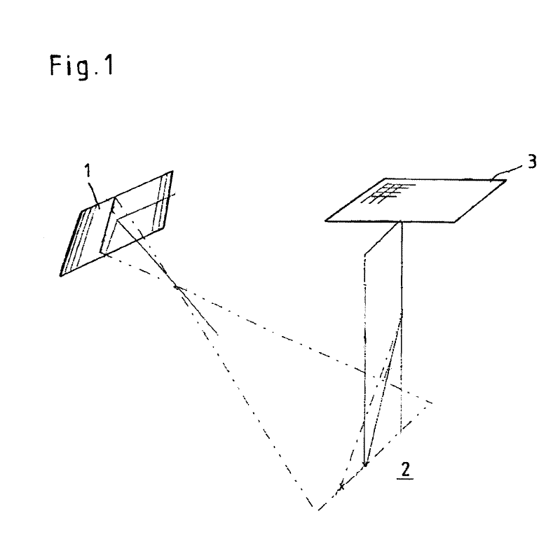

The device depicted in merely schematic manner in FIG. 1 for optically determining the color of objects consists of a light source 1 for illuminating an object 2 whose color is to be detected, as well as a sensor element 3 for detecting color data emitted by the object 2.

The sensor element 3 is a monochromatic, preferably black-and-white CCD (charge-coupled-device) video camera. The sensor element 3 (CCD video camera) is composed of a number of individual pixels, which all are sensitive in the same wavelength range.

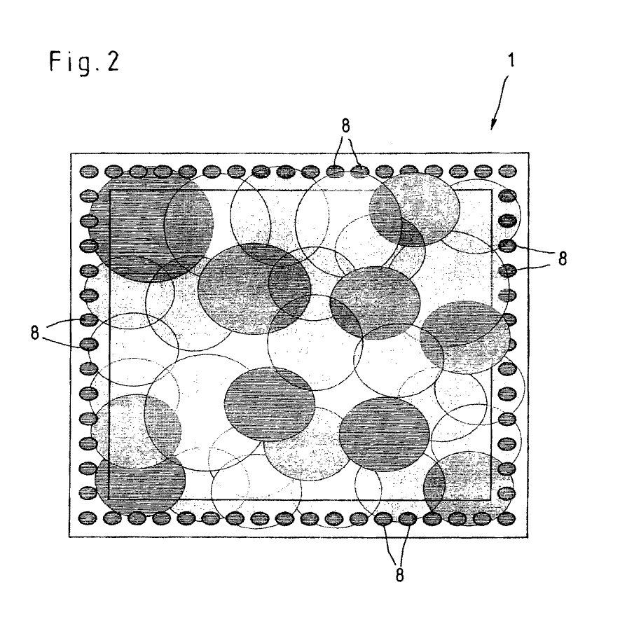

The operation of the optical color determination of objects by means of this device is described hereafter with reference to FIGS. 2 to 4, where the illustrated and described sensor element 3 is a black-and-white CCD element.

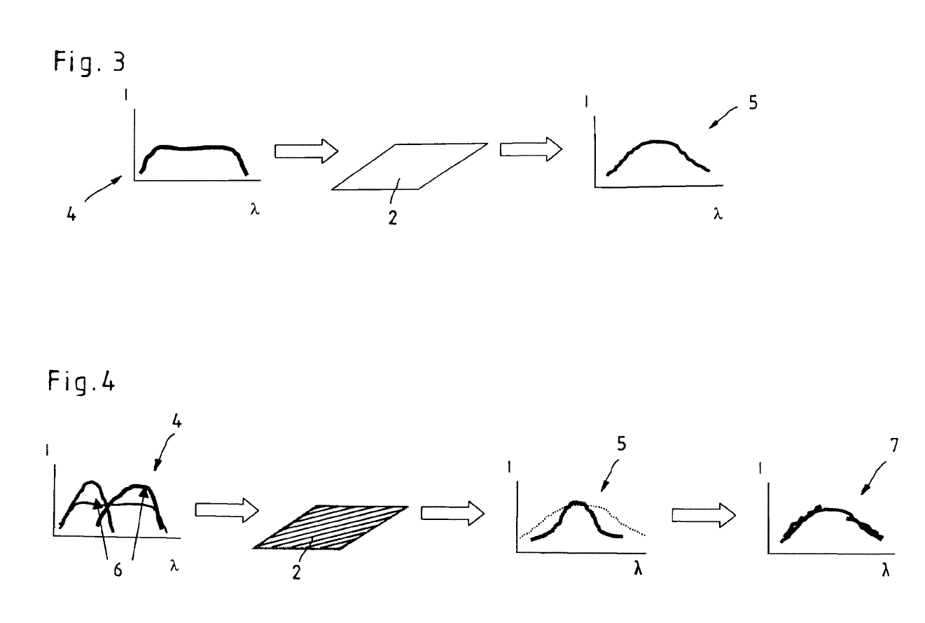

In the first step of the method, at least one reference value is ascertained by means of an object 2 with known color information. In this calibration process illustrated in FIG. 3, a white object 2 is illuminated by the light source 1 with white light whose intensity wavelength diagram is portrayed as illumination diagram 4 in FIG. 3 at left.

The color data emitted by the white object 2 illuminated in this manner with white light are detected by the black-and-white sensitive pixels of the sensor element 3 and are portrayed in turn in an intensity wavelength diagram, the video camera diagram 5. This video camera diagram 5 obtained in this way is individually characteristic for the employed CCD video camera and shows how a purely white object 2 is pictured with this sensor element 3.

In order now to be able to determine the color of various objects 2 with a black-and-white CCD video camera, in the second step of the process the color data emitted by an unknown object 2 are equalized by individually adjusted illumination of the object 2 by the light source 1 in such a way that the color data correspond to the previously ascertained reference values (video camera diagram 5).

The equalizing of the color data in the second step of the process is depicted schematically in FIG. 4.

The object 2 to be investigated is, for instance, a green object 2, which in the video camera diagram 5 provides the intensity wavelength path that is depicted by the continuous line and clearly distinguished from the path of the reference value of the white object 2, which is depicted with dots.

To equalize the curve of these detected color data on the white curve, it is necessary to illuminate the body 2 by the light source 1 with red and blue light portions. In the illumination diagram 4 the intensity wavelength paths of pure red and blue light are distributed with respect to the intensity wavelength path of white light known from FIG. 3 for this purpose. The areas of the curves are marked with arrows 6 and must be corrected by appropriate adjustment of the illumination in order then to receive the equalized path of the curve emitted in the equalization diagram 7 depicted at the far right.

For this purpose the light source 1 consists preferably of a number of individual illuminating elements 8 (FIG. 2), in particular light-conducting fibers, which can be individually controlled with light in the colors red, green, and blue, so that in addition every color can be adjusted individually with respect to the color tone and/or the brightness and/or color intensity in order to adjust the equalization diagram 7 as precisely as possible to the reference value.

FIG. 2 shows in exemplary manner an individual illumination field generated from the light source 1. In this depiction nearly every one of the illuminating elements 8 surrounding the illumination area gives off light in a different color tone, a different brightness, and/or different color intensity.

From the known adjustments of the illuminating elements 8 of the light source 1, which were necessary in order to equalize to the reference value the detected color data of an object 2 whose color is to be determined, in a third step of the process the color of the object to be determined can be calculated.

Thus with this method it is possible, despite the use of only one black-and-white CCD video camera, to conduct an exact color determination of the objects 2 to be examined. Because only one pixel is necessary to ascertain the entire color data, a resolution density three times higher than the known color CCD video camera can be achieved, because in each case it demands a red, a green, and a blue sensitive pixel for the complete color detection.

To be able also to ascertain color processes of the object 2, the surface of the object 2 to be observed is preferably covered by points or by lines.

1. A method for optically determining the color of objects by means of at least one light source for illuminating the object as well as a sensor element for detecting the color data emitted by the object characterized by the process steps:
a) Ascertain at least one reference value by means of an object with known color data;
b) Equalize the detected color data of an object to be determined to the at least one reference value ascertained in step a) by means of an illumination of the object to be determined that can be adjusted individually with respect to color;
c) Determine the color of the object from the comparison in step b) of adjusted illumination color values with the at least one reference value ascertained in step a) of the process;

2. A method according to claim 1, characterized in that the values adjusted in step b) are stored as reference values for the color determined in step c) and are re- trieved for the ensuing color determinations.

3. A method according to claim 1, characterized in that in process a) of the process an intensity wavelength diagram is used as reference value.

4. A method according to claim 1, characterized in that in step b) of the process for individual adjustment of the illumination, the color ton and/or brightness and/or color intensity of every individual illuminating element of the light source can be individually adjusted.

5. A method according to claim 4, characterized in that light in the colors red, green, and/or blue can be irradiated onto the object to be determined by every illuminating element of the light source.

6. A method according to claim 1, characterized in that the surface of the object is divided into individual partial surfaces, so that the color of each partial surface is individually determined.

7. A device for optical color determination of objects by means of the method according to claim 1, with a light source for illuminating the object as well as a sensor element for detecting the color data emitted by the object, characterized in that the sensor element is a monochromatic, preferably black-and-white CCD video camera.

8. A device according to claim 7, characterized in that the light source consists of a number of individually controllable illumination elements, preferably light conducting fibers.
